(19) United States
(12) Patent Application Publication
(10) Pub. No.: US 2012/0262461 A1
(43) Pub. Date: Oct. 18, 2012

(54) System and Method for the Normalization of Text

(75) Inventors: Samuel H. Fisher, Greenville, SC (US); John E. Keane, Metuchen, NJ (US)

(73) Assignee: Conversive, Inc., Agoura Hills, CA (US)

(21) Appl. No.: 13/399,409

(22) Filed: Feb. 17, 2012

Related U.S. Application Data
(60) Provisional application No. 61/443,980, filed on Feb. 17, 2011.

(51) Int. Cl. G06T 11/00

(52) U.S. Cl. 345/467

(57) ABSTRACT

A computer-implemented method of normalizing abbreviated text to substantially unabbreviated text, performed on at least one computer system comprising at least one processor, includes generating, based at least partially on data in at least one data resource comprising abbreviated text associated with unabbreviated text, a plurality of transformation functions in at least one order; transforming at least one string with at least one of the transformation functions, wherein the at least one string at least partially comprises abbreviated text; and determining if at least a portion of the at least one string has been at least partially transformed to substantially unabbreviated text. A system and a computer program product for implementing the aforementioned method includes appropriately communicatively connected hardware components.

### CROSS REFERENCE TO RELATED APPLICATIONS

This application claims benefit of priority from U.S. Provisional Patent Application No. 61/443,980, filed Feb. 17, 2011, which is incorporated herein by reference in its entirety.

### BACKGROUND OF THE INVENTION

1. Field of the Invention

The present invention relates to normalization of strings of text and, in particular, a system, method and computer program product for normalizing strings of abbreviated or shorthand text to unabbreviated or longhand text.

2. Description of Related Art

The growing use of text-speak (“txtspk”)—the highly idiosyncratic and abbreviated writing common in short text message contexts, such as SMS messages, online chat, and social media—in electronic discourse poses an interesting problem for developers of automated text processing applications. In many of the contexts in which such applications operate, people are shifting away from communicating with standard forms of English and instead are using this rapidly evolving morphological variant of English.

The need to interpret txtspk can occur in many commercial contexts, including usage with down-stream natural language processing (NLP) systems, such as text search, automatic knowledge acquisition, part-of-speech tagging, named entity recognition, machine translation, speech synthesis, and more. Further contexts may include interpreting txtspk for human audiences, such as customer support representatives and EFL speakers, accommodating txtspk in spell checkers and improving suggestions for spelling correction, and automatic generation/conversion of dictionary English into txtspk for social media, SMS messaging, and other compressed communications channels.

Even though expressions in txtspk correspond to expressions in standard English, the representations of phrases in txtspk are sufficiently different in that they pose interpretation problems for automated systems that evaluate written English. It is tempting to treat txtspk merely as standard English with idiosyncratic spelling, but it is more of an emerging orthographic dialect. It is desirable to be able to leverage investment in existing language interpretation systems designed to expect inputs in standard English. In order to do this, the systems must be able to deal with the significant differences between txtspk and standard English, such as irregular word segmentation, morphological reduction and expansion, phonotactic nuance, homophone and homograph use, and the like.

Because of these fundamental differences in expression, NLP applications designed to interpret standard English will have difficulty with txtspk. It can also be observed that txtspk is rapidly evolving, with no standard form, and many regional variations. Stochastic (probabilistic) methods of machine translation require very large collections of parallel text for training in order to be effective. Such systems also rely heavily on term alignment using parallel corpora. They do not adapt well to the rapidly changing nature of txtspk representation.

Current normalization approaches tend to be unsuitable for use with txtspk. For example, normalization often begins with the removal of punctuation. While punctuation is generally of little significance in understanding normal English, many txtspk terms incorporate punctuation as meaningful characters within their structures. While spelling normalization is often employed, incorrect word segmentation is not normally addressed.

Many attempts to normalize text utilize static or periodically updated look-up tables and/or mapped phrases to translate terms or phrases, and are therefore unable to adapt to changes and/or shifts in the use of abbreviated terms without requiring manual labor to update the tables and/or databases of terms. For example, U.S. Pat. No. 8,060,565 to Swartz only remaps acronyms. U.S. Pat. No. 7,949,534 to Davis et al. does not address txtspk normalization, and does not use any learning functions or search algorithms to provide efficient translations. U.S. Pat. No. 7,822,598 to Carus uses predetermined scores and sequences of features that are static, and are not influenced by any learning process. U.S. Pat. No. 7,802,184 to Battilana, U.S. Pat. No. 7,634,403 to Roth et al., and U.S. Pat. No. 7,630,892 to Wu et al. do not employ any search or learning process. U.S. Pat. No. 7,028,038 to Pakhomov does not use a search algorithm to provide an efficient translation, and only translates acronyms.

Thus, there is a need for an improved normalization method for converting abbreviated text to unabbreviated text.

### SUMMARY OF THE INVENTION

Generally, provided is a system, method, and computer program products for the normalization of text that address or overcome some or all of the deficiencies and drawbacks associated with existing systems. Preferably, provided is a system, method, and computer program product that normalizes at least one string of abbreviated text to substantially unabbreviated text.

According to one preferred and non-limiting embodiment of the present invention, provided is a computer-implemented method of normalizing abbreviated text to substantially unabbreviated text, the method performed on at least one computer system comprising at least one processor, the method comprising: generating, based at least partially on data in at least one data resource comprising abbreviated text associated with unabbreviated text, a plurality of transformation functions in at least one order; transforming at least one string with at least one of the transformation functions, wherein the at least one string at least partially comprises abbreviated text; and determining if at least a portion of the at least one string has been at least partially transformed to substantially unabbreviated text.

According to another preferred and non-limiting embodiment of the present invention, provided is a system to normalize at least one string at least partially comprising abbreviated text into substantially unabbreviated text, the system comprising: at least one computer system including at least one processor; a training module configured to create, at least partially based on data in at least one data resource comprising abbreviated text and associated unabbreviated text, at least one output comprising at least one specified order of transformation functions; and a run-time module configured to transform at least a portion of the abbreviated text to substantially unabbreviated text by applying at least one of the transformation functions.

According to a further preferred and non-limiting embodiment of the present invention, provided is a computer program product comprising at least one computer-readable medium including program instructions which, when executed by at least one processor of a computer, cause the computer to: generate, based at least partially on data in at least one data resource comprising abbreviated text associated with unabbreviated text, a specified order of transformation functions; transform at least one string at least partially comprising abbreviated text with at least one of the transformation functions; and determine if at least a portion of the at least one string has been at least partially transformed to substantially unabbreviated text.

These and other features and characteristics of the present invention, as well as the methods of operation and functions of the related elements of structures and the combination of parts and economies of manufacture, will become more apparent upon consideration of the following description with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification, the singular form of “a”, “an”, and “the” include plural referents unless the context clearly dictates otherwise.

### BRIEF DESCRIPTION OF THE DRAWINGS

FIG. 1 is a block diagram of one embodiment of a system to normalize text according to the principles of the present invention;

FIG. 2 is a flow diagram of one embodiment of a learning mode of a system to normalize text according to the principles of the present invention;

FIG. 3a is a flow diagram of one embodiment of a search process of a training module of a system to normalize text according to the principles of the present invention;

FIG. 3b is a flow diagram of one embodiment of a search and learning process of a training module and learning mode of a system to normalize text according to the principles of the present invention;

FIG. 4 is a flow diagram of one embodiment of a search process used in a run-time mode of a system to normalize text according to the principles of the present invention;

FIG. 5 is a flow diagram of one embodiment of a search process used in a run-time mode of a system to normalize text according to the principles of the present invention; and

FIG. 6 is a schematic diagram of a computer and network infrastructure according to the prior art for use in connection with a system to normalize text according to the principles of the present invention.

### DESCRIPTION OF THE PREFERRED EMBODIMENTS

For purposes of the description hereinafter, it is to be understood that the specific systems, processes, functions, and modules illustrated in the attached drawings, and described in the following specification, are simply exemplary embodiments of the invention. Hence, specific characteristics related to the embodiments disclosed herein are not to be considered as limiting. Further, it is to be understood that the invention may assume various alternative variations and step sequences, except where expressly specified to the contrary.

As used herein, the term “string” or “string of text” (hereinafter individually and collectively referred to as “string”) refers to one or more characters, such as alphanumeric characters, in a specified or defined order. A string may include one or more words and/or characters represented by any character set or language. In one preferred and non-limiting embodiment, strings include alphanumeric characters. A string may include characters organized in an array or other form of data structure, and may be manipulated or processed by string operators and/or functions provided by a programming environment or through user-defined functions and/or libraries. For example, possible operators may include, but are not limited to, append, assign, at, begin, insert, remove, capacity, clear, compare, concatenate, copy, empty, erase, find, find first, find first of, find last, find last of, + (plus), += (plus equals), − (minus), push, replace, reserve, substr, substitute, and swap. Operators may manipulate the string and/or return data relating to the string. It will be further appreciated that strings may be analyzed and/or processed with standard Boolean operators.

As used herein, the term “abbreviated text” refers to any type of non-standard text that may include, but is not limited to, shorthand text, expanded text (e.g., extra characters added), intentionally or unintentionally misspelled text, emoticons, a portion of a term, acronyms, contractions, or any type of conversational and/or colloquial expression.

The term “transform,” as used herein with reference to strings or other units of text, refers to a transformation and/or modification of text that at least partially normalizes abbreviated text to unabbreviated text or unabbreviated text to abbreviated text, or modifies text in other ways. Transformations of strings may be performed with any number of methods, function calls, and/or operators including, but not limited to, transformation functions and string operators described herein.

The present invention is directed to a system and method for translating abbreviated text into at least partially unabbreviated text. In one preferred and non-limiting embodiment of the present invention, a set of transform functions are formulated or learned to transform various characteristics associated with a form of abbreviated text (e.g., txtspk) to partially or substantiality unabbreviated form. The transform functions may use syntactical and/or morphological criteria for a particular type of abbreviated form, so that a preferred, specified, and/or optimal level of accuracy may be achieved in the translation process.

In one preferred and non-limiting embodiment, a search-based approach is used to learn various models, data sets, and/or train various functions or modules that may be used to improve and/or increase the accuracy of text transformation. With such an approach, the system and method may be less vulnerable to shifts, changes or other alterations in the abbreviated form being used, since the transformation functions represent fundamental, underlying processes that are used by individuals to abbreviate terms and/or phrases.

Starting with a data resource comprising abbreviated text and unabbreviated text, many transformation functions may be applied in an iterative manner. From this process, which may employ a node-based search or other algorithm, one or more specified (e.g., optimal, preferred, frequent, specified, etc.) sequences of transformation functions are identified and used to train heuristic functions, and to create a heuristic priority model for the transformation functions. The heuristic functions and priority model are then used in a run-time mode to help direct and improve the efficiency of the run-time mode that translates an inputted string of abbreviated text into substantiality unabbreviated text. As used herein, “substantially unabbreviated text” may refer to a portion or substring of a larger string, and is not limited to instances where an entire string is transformed. It will be appreciated that the system may transform at least a portion of any given string, including substrings and/or single characters, into substantially unabbreviated text.

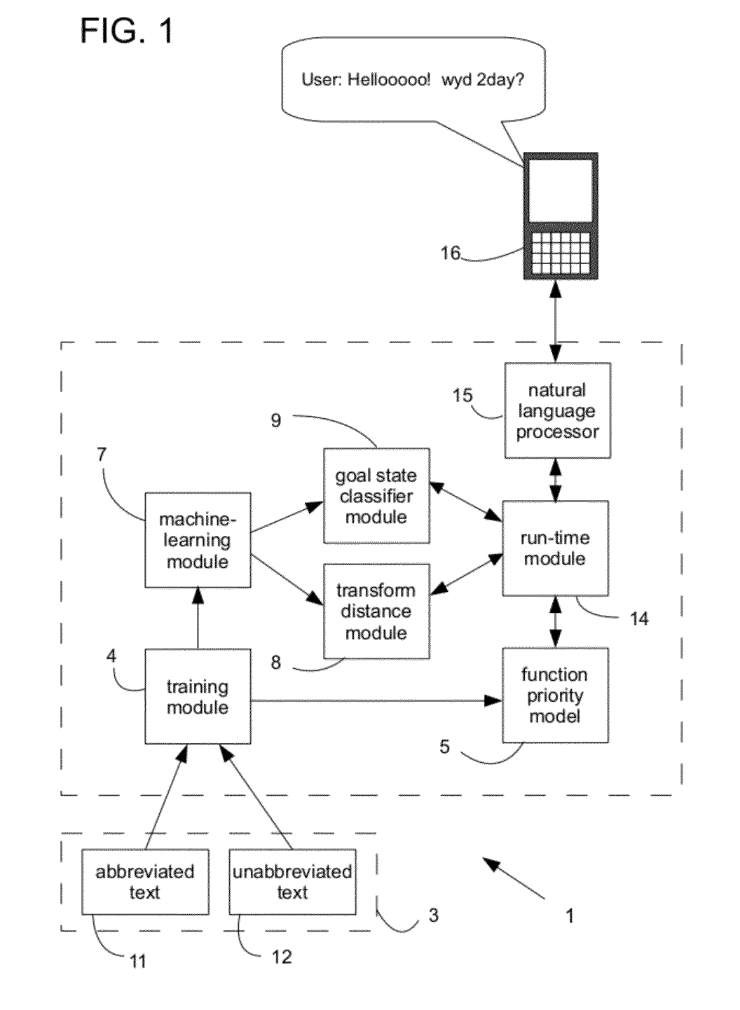

Referring now to FIG. 1, a system 1 for normalizing abbreviated text into unabbreviated text is shown according to one preferred and non-limiting embodiment of the present invention. A data resource 3 includes resources of abbreviated text 11 and unabbreviated text 12. One or more strings or units of abbreviated text 11 may be associated with one or more strings or units of unabbreviated text that represent translated versions of the abbreviated text. Abbreviated text, along with the associated unabbreviated text, is input into a training module 4. The training module 4 is configured to process portions of abbreviated text 11 with various transformation functions to reach the associated unabbreviated text 12. The training module 4 outputs various types of data including, but not limited to, a specified (e.g., optimal, preferred, or frequently used) order of transformation functions and/or an optimal path of nodes associated with a search algorithm.

With continued reference to FIG. 1, the output from the training module 4 is provided to a transformation function priority model 5 and a machine learning module 7. The transformation function priority model 5 may include one or more data structures, and may be associated with one or more functions and/or modules, and is used to indicate a specified order of transformation functions. The machine learning module 7 uses the output of the training module 4 to influence (e.g., train, impact, operate on, modify the functionality of, and/or modify data associated with) a goal state recognition classifier module 9 and a transform distance classifier module 8. The goal state recognition classifier module 9, after its functionality has been influenced by the machine learning module 7, is configured to predict or estimate, based on inputted text, whether at least a portion of text is in substantially unabbreviated form. The transform distance classifier module 8, after its functionality has been similarly influenced by the machine learning module 7, is configured to predict or estimate, based on inputted text, an approximate number of transformations that must be applied to the text in order to convert the text to substantially unabbreviated form.

Still referring to FIG. 1, a mobile device 16 or other form of computing device is in communication with a natural language processor 15. It will be appreciated that a device may also interact directly or indirectly with the run-time module 14. The communication may be in the context of an automated chat environment, for example, or other applications of a natural language processor 15. A run-time module 14 accepts a string of text from the device 16, either directly or indirectly, and passes data or a request to the transform function priority model 5, which returns one or more transformation functions in a specified order. During the run-time mode, the run-time module 14 may communicate text to a goal state recognition classifier module 9 and transform distance classifier module 8. The goal state recognition classifier module 9 returns data to the run-time module 14 indicating whether or not the text has been converted to partially or substantiality unabbreviated form. The transform distance classifier module 8 returns data to the run-time module 14 indicating a predicted or estimated number of transformations (e.g., a transformation distance) that will be required to convert a particular string to unabbreviated text.

The term “transformation distance,” as used herein, refers to an estimated number of string transformations that would be required for normalizing a particular input string or other unit of text from abbreviated form to partially or substantiality unabbreviated form.

The terms “module” or “function” refer to, but are not limited to, program components in a software architecture, or similarly configured electronic components. The terms “module” or “function” include, for example, a set of sub-instructions within the context of a larger software architecture that are designed to perform some desired task or action. The modules and functions may be distributed among platforms, or may be portions of program instructions of the same executable file and/or source code. It will be appreciated that various modules and functions, or portions thereof, may be local to the system 1, or may be accessed and utilized remotely over, for example, a network. Some modules or functions may take various parameters and return some form of data, although it will be appreciated that these components may not take any input parameters and may perform some task or action that does not involve the return of data.

In one preferred and non-limiting embodiment of the present invention, a data resource is developed, obtained, or identified that comprises abbreviated strings and unabbreviated strings. The data resource may be one or more data structures, and may also be referred to as a parallel text corpus or translation data structure. Some of the abbreviated strings may be mapped to one or more unabbreviated strings, or portions of unabbreviated strings. Mapping refers to a relationship between multiple sets of data in which one or more sets of data are linked or otherwise associated with one or more corresponding sets of data. In some instances, the unabbreviated strings will be at least partial translations of the corresponding abbreviated strings. In one example, the data resource 3 may be in the form of a database or table.

In a preferred and non-limiting embodiment, the abbreviated strings may be in the form of “text-speak” (“txtspk”), i.e., shorthand form used in electronic communications such as text messaging, internet chat, and e-mail. Txtspk itself can be characterized as a cryptic, compressed orthographic language form where redundant information typically codified in English text is deliberately reduced, temporal aspects of phonological enunciation of words and phrases are expressed orthographically, and/or semiotics find new representation as text.

These terms may include acronyms and sound-alikes such as, for example, “BRB”, “LOL”, “BCNU”, “l8r”, “gtg”, “cu”, etc., and be linked or mapped to the respective unabbreviated terms “be right back”, “laugh out loud”, “be seeing you”, “later”, “got to go”, “see you”, etc. The abbreviated text may also include shorthand forms that include removal of vowels and/or consonants (e.g., “tlk”, “txt”, “msg”, “r”, “ther” corresponding to “talk”, “text”, “message”, “are”, “there”), or other forms of shorthand that combine more than one term, or separate more than one term (e.g., “go n” corresponding to “going” and “cu” corresponding to “see you”). Punctuation may also represent characters, spaces, or other translations.

It will be appreciated that the abbreviated strings may also include other shorthand forms or abbreviated formulations, and that the unabbreviated strings may be in corresponding longhand forms in any number of languages and according to any other linguistic or grammatical criteria.

The abbreviated terms may be obtained or identified from any number of sources such as, for example, public data resources (e.g., social media comments and postings), and public or private databases/collections of abbreviated terms. The terms may also be manually compiled. The unabbreviated terms linked or mapped to associated abbreviated terms may be obtained or identified by translating the abbreviated terms This task may be performed by a computer using existing algorithms, may be performed manually, may be outsourced, or may be a combination thereof. In one non-limiting embodiment, the tasks associated with translating the abbreviated text and otherwise creating the data resource are crowd-sourced.

The terms “crowd-sourced” and “crowd-sourcing”, as used herein, refer to tasks or products of such tasks performed by a number of individuals. Crowd-sourcing also refers to a way of soliciting labor from a network of individuals. Usually, the network is an online community or crowd-sourcing specific website; however, any number of methods may be used. It will also be appreciated that crowd-sourcing tasks may be paid or unpaid. As used herein, a “crowd-sourced data source” refers to any a source of any data created, generated, or aggregated by multiple individuals, including but not limited to data produced by a crowd-sourcing platform, website, or service.

In a preferred and non-limiting embodiment of the present invention, a set of transform functions are provided to transform some or all the abbreviated text to partially or substantiality unabbreviated text. These functions may be designed to transform abbreviated text such as “txtspk” and other forms into proper grammatical form by using morphosyntactic rules (i.e., linguistic rules having criteria based on syntax and morphology), syntactical rules, or other grammatical rules. As used herein, “transformation function” refers to any function, module, set of object/source code, or operator capable of performing a task with a string, character, or unit of text. These tasks may involve, for example, inserting, removing, and/or rearranging one or more characters.

The transformation functions may be specified and inputted into the system, or may be from a combination of multiple sources. Once the data resource 3 is formulated or identified, the abbreviated and unabbreviated text may be examined to identify common syntactic and morphologic rules for transforming the abbreviated form of text to an unabbreviated form of text. In the example of txtspk shorthand form, the rules may include the removal of letters (e.g., vowels), the use of numbers for letters, words and/or phonemes (e.g., segments of pronunciations), the use of punctuation for one or more letters (e.g., “@” for “at”, “!” for “I”, etc.), and the substitution of letters with like-sounding letters and/or words (e.g., “c” for “see”, “8” for “ate”, etc.). These rules may be related to characteristics of abbreviated strings and corresponding transformation functions. It will be appreciated that the transformation functions may also consider the context of the text to be transformed. For example, in the context of “I'll be L8” or “I'll see you L8r,” the use of “L8” may correspond to “late,” replacing the “8” with the like-sounding “ate.” In a different context, such as “L8” on its own or surrounded by unrelated terms, a translation to “late” may not be accurate. In such a case, by considering the context, “L8” may be transformed to “later” or “see you later.” As another example, the “r” in “r u going” may be transformed to “are” based on the context of its use. However, in a different context, such as “r house is messy,” “r” may be transformed to “our” based on the context in which it is used.

In one preferred and non-limiting embodiment of the present invention, the transformation functions may be formulated or associated with standard string operators, or may be associated with various modules and/or functions that input a string of text and modify that string in any number of ways. It will be appreciated that transformation functions may be a static set of functions, may be user-defined, or may be a result of machine learning and/or user feedback.

Some possible transformation functions may include, but are not limited to, InsertSpace (e.g., inserting one or more space characters in front of, behind, or between characters in a string), TermSubstitution (e.g., replacing one substring with another substring), InsertVowels, SwapGraphemesBySimilarPhoneme (e.g., replace one or more characters with one or more characters having like sounds), ConvertLookALikes, ConvertNumberToLetters, ReduceExcessiveLetters (e.g., change “helloooo” to “hello”), ReduceExcessivePunctuation, ReduceExcessiveNumbers, RemoveSpace, Swap2ndAnd3rdCharsOfTerm, Swap3rdAnd4thCharsOfTerm, RemoveSingleCharacter, InsertConsonants, InsertNumber, RemoveConsonants, RemoveVowels, ChangeVowel, ChangeLiquid, ChangeNasal, Borrow1stLetterFromNextWord, InsertSingleQuote, and/or Insert Punctuation. Further examples may include InsertConsonant, InsertVowel, RemoveVowel, ChangeVowel, InsertSingleQuote, RemoveSpace, InsertDot, RemoveExclamation, RemoveDot, RemoveNumber, RemoveSingleQuote, InsertDash, RemoveComma, RemoveForwardSlash, RemoveStar, InsertUnderscore, InsertExclamation, RemoveColon, RemoveDollarSign, RemoveSemicolon, InsertNumber, RemoveDash, RemoveUnderscore, RemoveAmpers, RemovePercent, InsertComma, InsertAmpers, InsertDot, InsertComma, InsertDash, InsertExclamation, InsertDoubleQuote, InsertSingleQuote, InsertLeftParens, InsertRightParens, InsertColon, InsertSemicolon, InsertDollarSign, InsertEqualSign, InsertLessThan, InsertGreaterThan, InsertForwardSlash, InsertLeftBracket, InsertRightBracket, InsertLeftCurly, InsertRightCurly, InsertPercent, InsertPound, InsertAtSign, InsertCarat, InsertStar, InsertPlus, InsertUnderscore, InsertTilda, InsertBackwardSlash, InsertForwardSlash, RemoveAmpers, RemoveDot, RemoveComma, RemoveDash, RemoveExclamation, RemoveDoubleQuote, RemoveSingleQuote, RemoveLeftParens, RemoveRightParens, RemoveColon, RemoveSemicolon, RemoveDollarSign, RemoveEqualSign, RemoveLessThan, RemoveGreaterThan, RemoveForwardSlash, RemoveLeftBracket, RemoveRightBracket, RemoveLeftCurly, RemoveRightCurly, RemovePercent, RemovePound, RemoveAtSign, RemoveCarat, RemoveStar, RemovePlus, RemoveUnderscore, RemoveTilda, RemoveBackwardSlash and RemoveForwardSlash.

For example, “LOLd” may be translated to “laughed out loud” with a dictionary look-up function. The term “wid” may be translated to “with” by a phonemic substitution function. The term “4ever” may be translated to “forever” by a number-phoneme substitution, “loooove” may be translated to “love” with redundant letter removal, and “wlk” may be translated to “walk” with a vowel insertion function.

In one preferred and non-limiting embodiment, a learning mode develops heuristic functions and/or models for application in a run-time mode. A training module 4 is configured to perform a node-based search to develop a heuristic priority model 5 for transformation functions and to create a heuristic function training data set 6. The search algorithm used by the training module 4 may include, but is not limited to, a best-first node-based algorithm. A string of abbreviated text may become a root node, and the associated string of unabbreviated text may be a goal, or goal node. In one example, the training module 4 is configured to apply all known transformation functions to the abbreviated terms in various ways, creating a series of successor nodes representing various iterations of text transformed by the transformation functions. The output of the training module 4 may be referred to as a training data set 6, and may include data relating to the series of successor nodes, statistical data relating to the transformation functions applied, features of the successor nodes, and other related data.

The successor nodes that show improvement (e.g., have transformed a parent node and/or the root node further toward a desired unabbreviated form, e.g., the goal node) are used to formulate a heuristically preferred, specified, and/or optimal path of nodes. Each node may be associated with text, a distance (e.g., depth from the root node in the search structure), a particular transformation function, etc. The path of nodes represents one or more orders of transformation functions.

A heuristic priority model 6 for transformation functions is generated, at least in part, from the output of the training module 4. The training module 4 outputs specified transformation functions (e.g., optimal, preferred, or frequently-used transformation functions) in a specified order as a result of the search process of the abbreviated terms in the data resource 3. The heuristic priority model 5 may be associated with a module and/or function designed to accept a string and to determine what transformation function to apply next. The heuristic priority model 5 may be a learned, ranked order of the various transformation functions that may be created by statistical analysis of the search sequences. In a preferred and non-limiting embodiment, the order (e.g., ranking) of the transformation functions may be based on frequency of use of the transformation functions during the learning mode, based on the iterations through the abbreviated text in the data resource 3. For example, the transformation functions may be listed from most commonly used to least commonly used (e.g., frequency of use) based on statistics associated with the heuristically optimal path derived from the learning mode.

The path of nodes output by the training module 4, resulting from the search process of the abbreviated text 11 in the data resource 3, may also be used to create a heuristic function training data set 6. The heuristic function training data set 6 may include, for example, a ranked order of various transformation functions and any other data or statistics created or output by the search process. The data set 6 may be in the form of one or more data structures such as, but not limited to, trees, graphs, stacks, queues, arrays, lists, and maps. This data set 6 may be used to influence (e.g., train, impact, operate on, modify the functionality of, and/or modify data associated with) various models, modules and/or functions that may be used in the run-time mode of the present invention to evaluate one or more strings.

In one preferred and non-limiting embodiment, the heuristic function training data set 6 may be inputted to a machine learning module 7 that applies one or more algorithms to the data of the data set 6 for training heuristic functions. The heuristic functions may help guide the search process in a run-time mode. It will be appreciated that any number of applicable machine learning algorithms may be utilized by the machine learning module, and that different algorithms may be used to train different heuristic functions. The machine learning module 7 may create one or more classifiers for a given data set that may be binary (e.g., true or false) or numeric. By using multiple data sets to train the heuristic functions, the heuristic functions are able to provide better predictions or estimates based on inputted strings.

In a preferred and non-limiting embodiment, a goal state recognition classifier module 9 (e.g., termination function) may be one of the heuristic functions subjected to the machine learning module 7 and used in a run-time mode of the present invention. The goal state recognition classifier module 9 may be trained with any number of machine learning algorithms such as, but not limited to, the Random Forest classifier algorithm or other ensemble-based algorithms. The goal state recognition classifier module 9 is designed to take a string as a parameter and to return a binary classification indicating that the string is either normalized or not normalized. However, it will be appreciated that any number of classifiers or returns may be used, including but not limited to forms of numeric scoring. The goal state recognition classifier module 9 may be associated with one or more models, data structures, or other types of data that are influenced with the machine learning module 7.

In a preferred and non-limiting embodiment of the present invention, a transform distance classifier module 8 is provided as a heuristic function subjected to the machine learning module 7 and used in a run-time mode of the present invention. The transform distance classifier module 8 may take a string as a parameter and return a numeric value representative of an estimated or predicted number of transformations required to substantially translate at least a portion of the string from abbreviated form to unabbreviated form. Likewise, the numeric value may additionally be representative of an estimated or predicted depth in a node-based graph associated with a search algorithm. For example, given a string of “2day”, the transform distance classifier module 8 may output “1”, indicating that one (1) transformation is required to translate “2day” to “today.” The algorithm applied to the heuristic function data set 6 by the machine learning module 7 may include, for example, an instance-based k-nearest neighbor classifier, or other instance-based learning algorithm. However, it will be appreciated that any number of learning algorithms may be employed. The transform distance classifier module 8 may be associated with one or more models, data structures, or other types of data that are influenced with the machine learning module 7.

In one preferred and non-limiting embodiment of the present invention, a feature extraction module is provided. The transform distance classifier module 8, the goal state recognition classifier module 9, the machine learning module 7, and any other function and/or module of the present invention may use the feature extraction module to extract various features from strings of text. The feature extraction module is configured to take a string as an input, and to return a vector of features. The vector of features may be in the form of an abstract real-valued numeric representation of the text of that inputted string (hereinafter individually and collectively referred to as a “feature vector”). It will be appreciated that the features may be organized in other types of data structures, including various types of arrays, stacks, lists, queues, and other constructs used to organize data.

The feature extraction module may be used in both the learning and run-time modes of the present invention. The feature vector may indicate various features including, but not limited to, the proportion of dictionary words contained within the text, the proportion of words contained within the text that exist within the unabbreviated text of the data resource 3, and the proportion of permissible character sequences (substrings) ranging, for example, from 2 to 4, and contained within the text that also exist within the set of permissible character sequences. Permissible character sequences may be derived from, for example, the unabbreviated text of the data resource and the dictionary, from some other text resource, or split into two distinct features, where one is derived only from the unabbreviated text of the data resource and the other only from the dictionary.

Other features may include, for example, the proportion of impermissible (or “impossible”) English letter sequences (substrings) ranging, for example, from 2 to 4, and contained within the text, the proportion of characters in the text (e.g., length) greater than the initial input string, the proportion of characters in the text (e.g., length) less than the initial input string, the proportion of tokens (e.g., one or more characters corresponding to a symbol) in the text matching a specified penalty pattern, such as beginning with a special character or punctuation, the proportion of tokens in the text matching a specified penalty pattern, such as containing letter-punctuation-letter sequences, the average token length skew (e.g., a real-valued number between 0 and 1 based on a distribution curve of the average length of tokens in the text against a set of z-score thresholds), the proportion of tokens in the text whose length is greater than a specified threshold length, and a real number resulting from a linear equation comprised of values associated with other features in the feature vector and a pre-defined weight for each. However, it will be appreciated that further features may be extracted from strings.

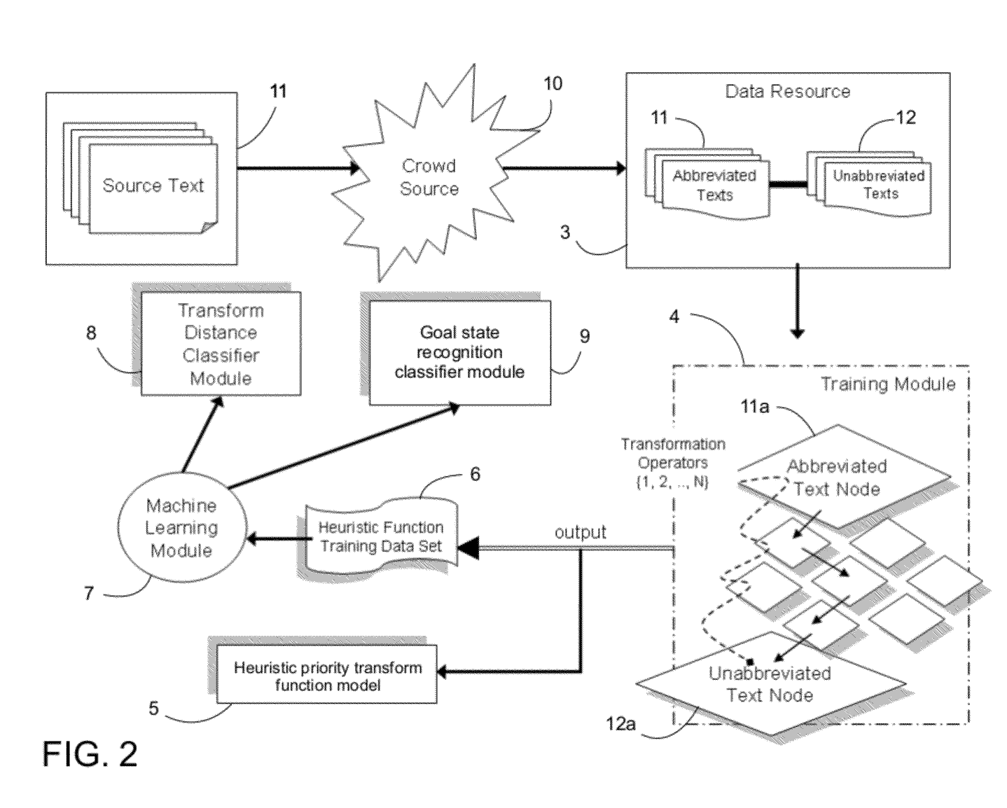

Referring now to FIG. 2, a flow diagram is shown for one preferred and non-limiting embodiment of a learning mode of the system according to the principles of the present invention. A data resource 3 (e.g., translation data structure) is created from a source of abbreviated text 11, such as but not limited to postings, comments, messages, etc., culled from public data sources or other data sources, or inputted manually. Terms or phrases of the abbreviated text are paired with associated unabbreviated terms or phrases 12 through a crowd-sourcing platform 10 providing a crowd-sourced data source, or other methods. The data resource 3, now including abbreviated terms 11 and unabbreviated terms 12, is used to create a heuristic function data set 6 and a heuristic priority model 5 of transformation functions. A series of transformation functions are applied to a string or substring 11a of the abbreviated text 11 in an iterative fashion and the result is compared to a corresponding string or substring 12a of the unabbreviated text 12. The iterations that result in the abbreviated string or substring 11a being transformed, wholly or partially, to the corresponding unabbreviated string or substring 12a may be analyzed and, based on the frequency of use of the associated transformation function, one or more ordered lists of effective, preferred, and/or frequently used transformation functions may be created. The ordered list may also be in the form of an optimal or preferred path of nodes associated with transformation functions. The nodes may additionally be associated with text and other data.

With continued reference to FIG. 2, once an optimal, preferred, and/or specified path of nodes is generated, it is added to the heuristic function training data set 6, which may be one or more data structures of various types. The training data set 6 is then inputted into a machine learning module 7 which uses one or more machine learning algorithms to train (e.g., influence) the transform distance classifier module 8 and the goal state recognition classifier module 9.

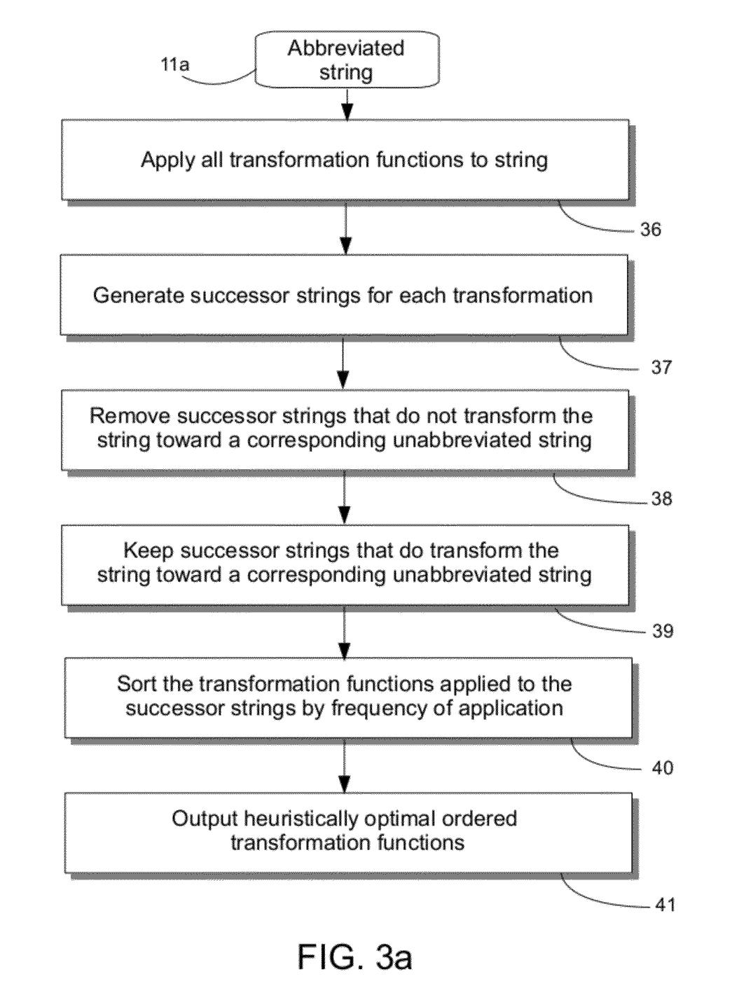

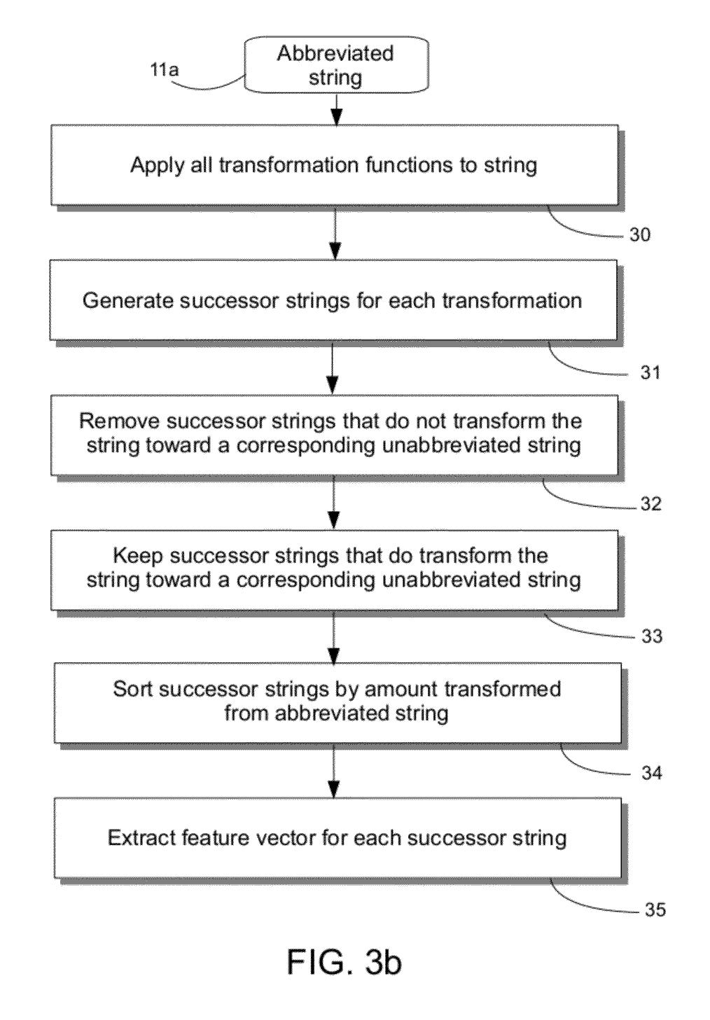

Referring now to FIG. 3a, a flow diagram is shown for one preferred and non-limiting embodiment of a search process performed by the training module 4 according to the principles of the present invention. Starting with a string or substring 11a of abbreviated text, a first step 36 involves the application of all transformation functions to the string 11a. In a second step 37, each of these transformation functions applied to the string 11a generate successor strings that are modified versions of the string 11a. As a third step 38, all successor strings that do not transform the string 11a toward a corresponding unabbreviated string 12a (not shown) are removed from the list and/or data structure of the successor strings. As a fourth step 39, all successor strings that do transform the string 11a closer to a corresponding unabbreviated string 12a (not shown) are kept. As a fifth step 40, the transformation functions applied to the kept successor strings are sorted by the frequency applied. Finally, as a sixth step 41, a heuristically optimal order of transformation functions is outputted.

With reference to FIG. 3b, a flow diagram is shown for one preferred and non-limiting embodiment of a search and learning process performed by the training module 4 and/or other modules in a learning mode of the present invention. Starting with a string or substring 11a of abbreviated text, a first step 30 involves the application of all transformation functions to the string 11a. In a second step 31, each of these transformation functions applied to the string 11a generate successor strings that are modified versions of the string 11a. As a third step 32, all successor strings that do not transform the string 11a toward a corresponding unabbreviated string 12a (not shown) are removed from the list and/or data structure of the successor strings. As a fourth step 33, all successor strings that do transform the string 11a closer to a corresponding unabbreviated string 12a (not shown) are kept. As a fifth step 34, the successor strings are sorted by the amount transformed from the abbreviated string 11a. As a sixth step 35, a feature vector is extracted for each successor string to provide information regarding the string in the context of the machine learning module, or the transform distance module and/or the goal state classifier module (not shown).

Once the learning mode is completed, and the training module 4 output has created a heuristic function priority model 5 and trained (e.g., influenced) the transform distance module 8 and goal state recognition module 9 (e.g., heuristic functions), the run-time module 14 may be executed with an inputted string. The run-time module 14 takes one or more strings as parameters and, using the heuristic function priority model 5, the transform distance module 8, and the goal state recognition module 9, at least partially transforms the strings to substantially unabbreviated text.

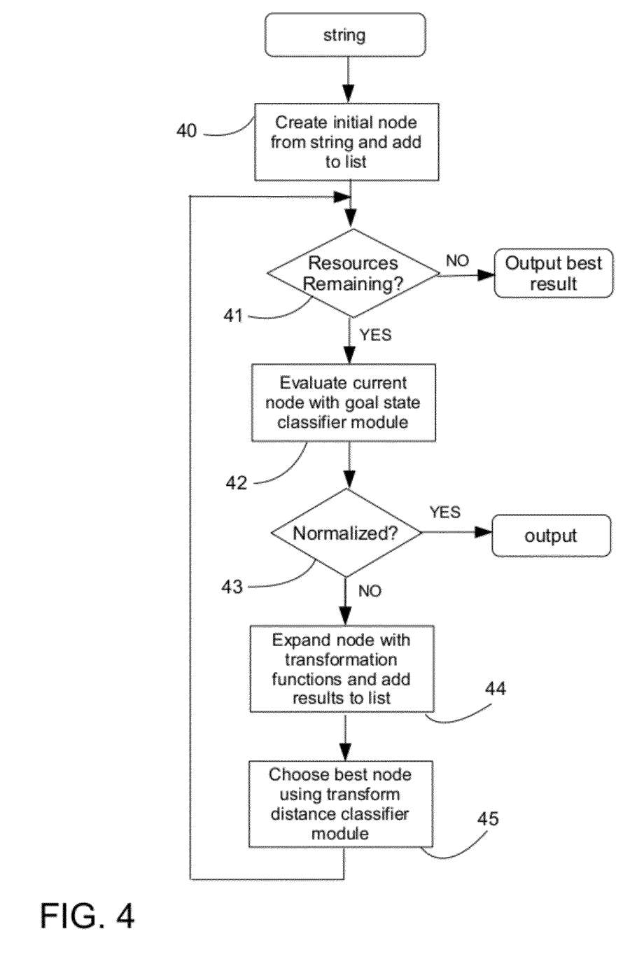

Referring now to FIG. 4, a flow diagram is shown for another preferred and non-limiting embodiment of a search process used in the run-time mode of the system according to the principles of the present invention. Starting with a string, an initial node is created from the string and added to a list (e.g., agenda) as a first step 40. If resources are still remaining 41, as a next step 42, the system evaluates the current node with the goal state recognition classifier module 9 (not shown). In one preferred and non-limiting embodiment of the present invention, the goal state recognition classifier module 9 will return a binary output indicating whether the string is normalized or not normalized. Based on this output, as a next step 43, the system determines if the string is normalized If it is, the transformed string (or, if the string had no abbreviated text, the original string) is output. If the string is not normalized, the system proceeds to a next step 44 in which the current node is expanded with transformation functions and the results (e.g., successor nodes) are added to a list (e.g., agenda). As a next step 45, the best node is chosen from the successor nodes using the transform distance classifier module 8 (not shown). The system then proceeds by looping back to step 41.

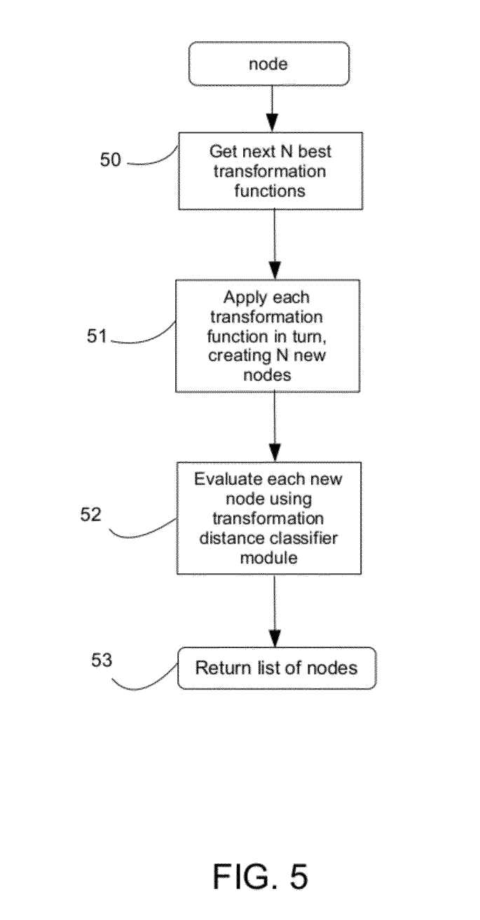

Referring now to FIG. 5, a flow diagram is shown for one preferred and non-limiting embodiment of a process for expanding a node in the search process used in the run-time mode of the system according to the principles of the present invention. Starting with a node that has been determined to be not fully normalized (at step 44 of FIG. 4, for example), as a next step 50 the system retrieves a list of the next N best transformation functions from the heuristic priority transformation function model 5. As a next step 51, each transformation function is applied in turn, creating N new nodes. In a next step 52, each new node is evaluated using the transform distance classifier module 8 (not shown). In a next step 53, the list of nodes is returned, allowing the best node to be chosen based on the result of the transform distance classifier module 8 (not shown).

The run-time module 14 may begin with a string of abbreviated text, which it may create into a root node. The string may then be inputted into the feature extraction module, which returns a feature vector for the string. The run-time module 14 may then pass the string and/or the feature vector to the transform distance classifier module 8 to obtain an estimated number of transformations needed, and to the goal state recognition classifier module 9 to determine if the string is already in unabbreviated form. If the string is in the specified unabbreviated form, the run-time module 14 may then terminate and output the resulting string. If the string is not in the specified unabbreviated form, the process may be continued, as described by FIGS. 4 and 5, and the heuristic transformation function priority model 5 may be applied to select the next (or first) transformation function to apply to the string.

As another example of the process executed by the run-time module 14, two functions may be created, such as, for example, NormalizeUsingSearch, which takes a string as a parameter, and ExpandNodeWithFunctions, which takes a node of a search pattern (e.g., graph) as a parameter. FIG. 4 illustrates a flow diagram that may be used by the NormalizeUsingSearch function, and FIG. 5 illustrates a flow diagram that may be used with the ExpandNodeWithFunctions function. In the NormalizeUsingSearch function, a variable and/or object called CurrentNode may be created with the string and estimated transform distance as parameters. The CurrentNode is added to a list and a loop (e.g., a “while”, “do while”, or “for” statement, or any other control flow statement) is run while the list is not empty and there are computation resources remaining. In the loop, it may be first checked if the text of the CurrentNode has reached its goal state (e.g., unabbreviated form) by calling the goal state recognition classifier module 9. If it has not reached its goal state, the list is expanded with the return of the ExpandNodeWithFunctions function and the CurrentNode is set to the “best” (e.g., most transformed) node from the newly expanded list. Once the loop terminates, the text of the CurrentNode is returned.

The ExpandNodeWithFunctions function, called from the NormalizeUsingSearchfunction, applies specified (e.g., optimal, preferred, or frequently used) transformation functions, chosen from the transformation function priority model 5, to a node. The function then returns an array (or other like data structure) of newly created nodes having undergone a transformation.

In one preferred and non-limiting embodiment of the present invention, the resulting output string (e.g., return) of the system is output to a natural language processor. The system 1 may be used, for example, in the context of an automated chat environment in which a user inputs a string that is unable to be processed or otherwise fully parsed. In this example, “txtspk” or other abbreviated forms of text inputted by a user will be translated into unabbreviated text that will be able to be processed by the automated chat system, including an associated natural language processor. In another non-limiting embodiment of the present invention, the resulting unabbreviated or normalized text is communicated to a human agent. It will be appreciated that the system 1 will also be of use in a number of other applications including, but not limited to, text messaging services, mobile device applications, and social media.

The process of choosing the next optimal transformation function is repeated until the string, or a portion thereof, has been substantially transformed to unabbreviated text, or until an exception occurs. An exception may include, for example, running out of computation resources or a budgeted amount of resources, an error occurring, or other events that occur within the context of the run-time mode.

As an example, the string “hellooooo there how r u?” may be inputted into the system. For this string, the first optimal transformation function may reduce excessive letters in a term or phrase (e.g., ReduceExcessiveLetters), transforming the text to “hello there how r u?” The second transformation function may substitute one substring or segment of text for another, in this case substituting “r” for “are” and “u” for “you,” based on a look-up table or other form of mapped data structure. Thus, the system outputs the string “hello there how are you?” One of the possible iterations may substitute “r” for “our” but, based on a scoring or result from one of the heuristic functions, the iteration containing “are” may be identified as the best or most optimal.

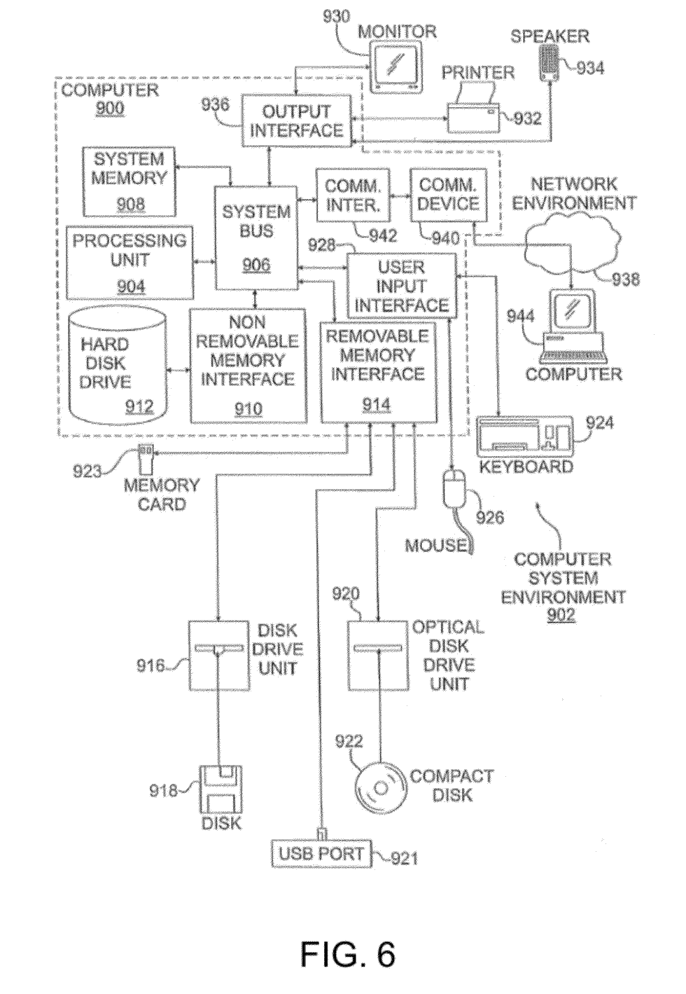

The present invention may be implemented on a variety of computing devices and systems, wherein these computing devices include the appropriate processing mechanisms and computer-readable media for storing and executing computer-readable instructions, such as programming instructions, code, and the like. As shown in FIG. 6, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 6, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 6 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Computer 944 represents one or more work stations appearing outside the local network and bidders and sellers machines. The bidders and sellers interact with computer 900, which can be an exchange system of logically integrated components including a database server and web server. In addition, secure exchange can take place through the Internet using secure www. An e-mail server can reside on system computer 900 or a component thereof. Electronic data interchanges can be transacted through networks connecting computer 900 and computer 944. Third party vendors represented by computer 944 can connect using EDI or www, but other protocols known to one skilled in the art to connect computers could be used.

The exchange system can be a typical web server running a process to respond to HTTP requests from remote browsers on computer 944. Through HTTP, the exchange system can provide the user interface graphics.

It will be apparent to one skilled in the relevant art(s) that the system may utilize databases physically located on one or more computers which may or may not be the same as their respective servers. For example, programming software on computer 900 can control a database physically stored on a separate processor of the network or otherwise.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method of normalizing abbreviated text to substantially unabbreviated text, the method performed on at least one computer system comprising at least one processor, the method comprising:
(a) generating, based at least partially on data in at least one data resource comprising abbreviated text associated with unabbreviated text, a plurality of transformation functions in at least one order;
(b) transforming at least one string with at least one of the transformation functions, wherein the at least one string at least partially comprises abbreviated text; and
(c) determining if at least a portion of the at least one string has been at least partially transformed to substantially unabbreviated text.

2. The method of claim 1, wherein the plurality of transformation functions in the at least one order are at least partially generated by applying a second plurality of transformation functions to at least a portion of the abbreviated text of the at least one data resource, such that specific transformation functions that at least partially transform the at least a portion of the abbreviated text to associated unabbreviated text are identified.

3. The method of claim 1, further comprising determining an estimated number of transformations needed to transform the at least one string to substantially unabbreviated text.

4. The method of claim 3, wherein the estimated number of transformations is compared to a total number of transformations performed on the at least one string to at least partially determine if the at least a portion of the at least one string has been at least partially transformed to unabbreviated text.

5. The method of claim 1, wherein the transformation functions are configured to at least partially modify at least one string of text.

6. The method of claim 1, wherein the at least one data resource is at least partially created from at least one of the following: at least one public data source, at least one private data source, at least one crowd-sourcing data source, or any combination thereof.

7. The method of claim 1, wherein step (a) is at least partially performed using at least one node-based search algorithm, and wherein at least a portion of the abbreviated text is associated with at least one root node, and wherein at least a portion of the unabbreviated text is at least one goal.

8. The method of claim 1, wherein at least a portion of the plurality of transformation functions is used to at least partially faun a training data set.

9. The method of claim 8, wherein at least a portion of the training data set is used to at least partially influence a transform distance module configured to return an estimated number of transformations for at least a portion of an inputted string.

10. The method of claim 8, wherein at least a portion of the training data set is used to at least partially influence a goal state recognition module configured to return at least one indication of whether at least a portion of an inputted string comprises substantially unabbreviated text.

11. The method of claim 1, further comprising repeating at least steps (b) and (c) until the at least one string is substantially converted to unabbreviated text or an exception occurs.

12. The method of claim 1, wherein at least one of the transformation functions is associated with at least one morphologic criteria.

13. The method of claim 1, wherein the at least a portion of the at least one string is outputted to at least one of the following: a natural language processor, an automated chat environment, a mobile communication device, a human agent, or any combination thereof.

14. The method of claim 1, wherein at least a portion of the abbreviated text comprises text-speak (txtspk) text.

15. A system to normalize at least one string at least partially comprising abbreviated text into substantially unabbreviated text, the system comprising:
at least one computer system including at least one processor;
a training module configured to create, at least partially based on data in at least one data resource comprising abbreviated text and associated unabbreviated text, at least one output comprising at least one specified order of transformation functions; and
a run-time module configured to transform at least a portion of the abbreviated text to substantially unabbreviated text by applying at least one of the transformation functions.

16. The system of claim 15, further comprising a transform distance module configured to determine, based at least partially on at least a portion of the at least one output, a specified number of transformations to transform at least one string comprising abbreviated text to substantially unabbreviated text.

17. The system of claim 15, further comprising a goal state recognition module configured to determine, based at least partially on at least a portion of the at least one output, whether at least one string comprises at least one of the following: abbreviated text, unabbreviated text, or any combination thereof.

18. The system of claim 15, further comprising a machine learning module configured to influence, based at least partially on at least a portion of the at least one output, a performance of at least one module configured to determine at least one of the following: a specified number of transformations to transform at least one string comprising abbreviated text to substantially unabbreviated text, whether at least one string comprises substantially unabbreviated text, or any combination thereof.

19. A computer program product comprising at least one computer-readable medium including program instructions which, when executed by at least one processor of a computer, cause the computer to:
(a) generate, based at least partially on data in at least one data resource comprising abbreviated text associated with unabbreviated text, a specified order of transformation functions;
(b) transform at least one string at least partially comprising abbreviated text with at least one of the transformation functions; and
(c) determine if at least a portion of the at least one string has been at least partially transformed to substantially unabbreviated text.

20. The computer program product of claim 19, wherein the plurality of transformation functions in the at least one order are at least partially generated by applying a second plurality of transformation functions to at least a portion of the abbreviated text of the at least one data resource, such that specific transformation functions that at least partially transform the at least a portion of the abbreviated text to associated unabbreviated text are identified.

21. The computer program product of claim 19, wherein the program instructions further cause the computer to determine an estimated number of transformations needed to transform the at least one string to substantially unabbreviated text.

22. The computer program product of claim 21, wherein the estimated number of transformations is compared to a total number of transformations performed on the at least one string to at least partially determine if the at least a portion of the at least one string has been at least partially transformed to unabbreviated text.

23. The computer program product of claim 19, wherein the at least one data resource is at least partially created from at least one of the following: at least one public data source, at least one private data source, at least one crowd-sourced data source, or any combination thereof.

24. The computer program product of claim 19, wherein step (a) is at least partially performed using at least one node-based search algorithm, and wherein at least a portion of the abbreviated text is associated with at least one root node, and wherein at least a portion of the unabbreviated text is at least one goal.

25. The computer program product of claim 19, wherein at least a portion of the plurality of transformation functions is used to at least partially form a training data set, and wherein at least a portion of the training data set is used to at least partially influence at least one of the following: a transform distance module configured to return an estimated number of transformations for at least a portion of an inputted string, a goal state recognition module configured to return at least one indication of whether at least a portion of an inputted string comprises substantially unabbreviated text, or any combination thereof.

26. The computer program product of claim 19, wherein the program instructions further cause the computer to repeat at least steps (b) and (c) until the at least one string is substantially converted to unabbreviated text or an exception occurs.

27. The computer program product of claim 19, wherein the at least a portion of the at least one string is outputted to at least one of the following: a natural language processor, an automated chat environment, a mobile communication device, a human agent, or any combination thereof.

28. The computer program product of claim 19, wherein at least a portion of the abbreviated text comprises text-speak (txtspk) text.
